(19) United States
(12) Patent Application Publication
(10) Pub. No.: US 2013/0120689 A1
(43) Pub. Date: May 16, 2013

(54) SURFACE LIGHT SOURCE AND LIQUID CRYSTAL DISPLAY DEVICE

(71) Applicant: Panasonic Corporation, Osaka (JP)

(72) Inventors: Tomoko IIYAMA, Osaka (JP); Daizaburo MATSUKI, Osaka (JP)

(73) Assignee: PANASONIC CORPORATION, Osaka (JP)

(21) Appl. No.: 13/728,599

(22) Filed: Dec. 27, 2012

Related U.S. Application Data
(63) Continuation of application No. PCT/JP2012/001368, filed on Feb. 29, 2012.

(30) Foreign Application Priority Data
May 31, 2011 (JP) 2011-121372

(51) Int. Cl. G02F 1/1335; G09F 13/04

(52) U.S. Cl. CPC G02F 1/133606; G09F 13/04
USPC 349/64; 362/97.1

(57) ABSTRACT

The light emitting device radiates light at an optical axis A and around the optical axis A, and includes a light source and a lens radially expanding the light from the light source. The light source includes a light emitting element and a fluorescent material covering the light emitting element and has an emission surface orthogonal to the optical axis. The lens is configured such that a refractive power in a first direction orthogonal to the optical axis differs from a refractive power in a second direction orthogonal to the optical axis and the first direction. An incident surface of the lens may include an anamorphic curved surface in which a curved shape in the first direction differs from a curved shape in the second direction.

### CROSS-REFERENCE TO RELATED APPLICATIONS

This is a continuation application of International Application No. PCT/JP2012/001368, with an international filing date of Feb. 29, 2012, which claims priority of Japanese Patent Application No.: 2011-121372 filed on May 31, 2011, the content of which is incorporated herein by reference.

### BACKGROUND OF THE INVENTION

1. Technical Field

The present disclosure relates to a surface light source having a configuration in which directionality of light emitted from light sources, such as a light emitting diode (hereinafter simply referred to as an “LED”), is expanded by a lens. The disclosure also relates to a liquid crystal display device in which the surface light source is disposed as a backlight at the back of a liquid crystal panel.

2. Description of the Related Art

In a backlight of a conventional large-size liquid crystal display device, many cold-cathode tubes are disposed immediately below the liquid crystal panel, and the cold-cathode tubes are used together with member(s) such as a diffuser plate and/or a reflector plate. Nowadays, the LED is used as the light source of the backlight. A luminous efficacy of the LED is improved, and expected as a low-power-consumption light source to replace a fluorescent lamp. In the light source for the liquid crystal display device, power consumption of the liquid crystal display device can be reduced by controlling lighting of the LED based on a video picture.

In the liquid crystal display device, many LEDs are disposed instead of the cold-cathode tube in the backlight in which the LED is used as the light source. Although the brightness can evenly be obtained on a surface of the backlight using the many LEDs, unfortunately cost increases because many LEDs are used. In order to solve the drawback, the approach that the number of LEDs is decreased by increasing an output per LED is promoted. For example, Japanese Patent Publication Laid-Open No. 2006-92983 proposes a light emitting device in which the surface light source having the even luminance is obtained by a small number of LEDs

In order to obtain the surface light source in which the surface light source having the even luminance is obtained by a small number of LEDs, it is necessary to enlarge an illumination region that can be illuminated by one LED In the light emitting device of Japanese Patent Publication Laid-Open No. 2006-92983, the light from the LED is radially expanded by the lens. Therefore, directionality of the light from the LED is expanded, and a wide range about an optical axis of the LED can be illuminated on the irradiated surface. Specifically, the lens used in the light emitting device of Japanese Patent Publication Laid-Open No. 2006-92983 is formed into a circular shape when viewed from above, and both a light incident surface and a light control output surface are rotationally symmetrical with respect to the optical axis. The light incident surface is formed into a concave surface. In the light control output surface, a portion near the optical axis is formed into a concave surface, and a portion outside the portion near the optical axis is formed into a convex surface.

On the other hand, Japanese Patent Publication Laid-Open No. 2008-10693 discloses a light emitting device in which a lens, in which a V-shape groove extending in a direction orthogonal to the optical axis is formed on the center of the light output surface, is used. According to the lens of the above light emitting device, the light from the LED is expanded while an angular distribution of a normal distribution is kept constant in the direction (a longitudinal direction) in which the V-shape groove extends. On the other hand, in a direction (a crosswise direction) orthogonal to the direction in which the V-shape groove extends, the light from the LED is expanded such that the angular distribution is largely recessed near the optical axis and such that the angular distribution is steeply raised on both sides of the optical axis.

### SUMMARY

In a current white LED, the white LED in which a YAG-based and/or TAG-based fluorescent material is provided in a blue LED element to generate pseudo-white light becomes a mainstream. The light source of the pseudo-white light is formed as follows. The blue LED element is bonded in a package, and a transparent resin with the fluorescent materials dispersed is filled so as to cover the blue LED element.

In the above light source, the pseudo-white light is obtained by blue light from the blue LED element and yellow light generated by the fluorescent material excited by the blue light. Thus a size of a blue light emission surface differs from a size of a yellow light emission surface. Therefore, in a case that such pseudo-white light is expanded using the lens of Japanese Patent Publication Laid-Open No. 2006-92983, the expansion of the light depends on the color, and color unevenness is generated on the irradiated surface in the surface light source, on which the light from the light source is irradiated. A tendency of the color unevenness becomes prominent when the lens with a stronger power expanding the light is used.

Since a luminous efficacy of the LED is being improved in recent years, there is a demand for a surface light source in which an irradiation area per one light source on the irradiated surface is enlarged, the luminance and the color are equalized, and the low-cost and energy-saving can be achieved.

The light emitting device of Japanese Patent Publication Laid-Open No. 2008-10693 does not satisfy the demand because anisotropy is intentionally generated in the radiated light.

In view of the above demand, the disclosure provides a surface light source and a liquid crystal display, in which the color unevenness generated on the irradiated surface due to the different colors included in the light source can be reduced to equalize the luminance and the color in a state that a light distribution lens having the power to widely expand the light is used.

In order to solve the problem, the disclosure has the following configuration.

In accordance with a first aspect of the disclosure, a surface light source includes: a plurality of light emitting devices disposed in line; and a diffuser plate which is disposed so as to cover the plurality of light emitting devices, and radiates light irradiated from the plurality of light emitting devices onto a irradiated surface while diffusing the light from a radiation surface. Each of the plurality of light emitting devices is a light emitting device that radiates the light on an optical axis and around the optical axis. The light emitting device includes: a light source having a light emitting element, and a resin that covers the light emitting element and fluorescent materials being dispersed in the resin; and a lens radially expanding the light from the light source. The lens has different refractive powers between a first direction orthogonal to the optical axis and a second direction orthogonal to the optical axis and the first direction.

The disclosure also relates to a liquid crystal display device including a liquid crystal panel and the above surface light source disposed on the back side of the liquid crystal panel.

According to the configuration mentioned above, in the lens of the light emitting device, the refractive power of the lens in the first direction orthogonal to the optical axis differs from the refractive power of the lens in the second direction orthogonal to the optical axis and the first direction, thereby reducing a total reflection component generated on the output surface side of the lens. Therefore, according to the disclosure, the color unevenness generated on the irradiated surface due to the different colors included in the light source can be reduced even if the lens having the strong power to expand the light is used.

Additional benefits and advantages of the disclosed embodiments will be apparent from the specification and Figures. The benefits and/or advantages may be individually provided by the various embodiments and features of the specification and drawings disclosure, and need not all be provided in order to obtain one or more of the same.

### BRIEF DESCRIPTION OF THE DRAWINGS

FIG. 1 is a configuration diagram of a liquid crystal display device according to a first embodiment of the disclosure;

FIG. 2 is a cross-sectional view taken on a line IIA(X)-IIA(X) of FIG. 1;

FIG. 3 is a plan view illustrating a light emitting device of the surface light source in FIG. 1;

FIG. 4(a) and FIG. 4(b) are plan views illustrating examples of arrays of the light emitting devices;

FIG. 5 is a configuration diagram of a surface light source according to a second embodiment of the disclosure;

FIG. 6 is a partial cross-sectional view of the surface light source in FIG. 5;

FIG. 7 is a plan view of a light emitting device according to a third embodiment of the disclosure;

FIG. 8A is a cross-sectional view taken on a line IIA-IIA of FIG. 7;

FIG. 8B is a cross-sectional view taken on a line IIB-IIB of FIG. 7;

FIG. 9A is a perspective view illustrating a specific example of a light source in FIG. 7;

FIG. 9B is a perspective view illustrating a specific example of the light source in FIG. 7;

FIG. 9C is a perspective view illustrating a specific example of the light source in FIG. 7;

FIG. 10 is a graph illustrating a luminance distribution on an emission surface of the light source used in the light emitting device in FIG. 7;

FIG. 11 is an explanatory view of a light emitting device according to Example 1;

FIG. 12A is a graph (of Table 1) illustrating a relationship between R and; sagAX and sagAY, which indicates an incident surface shape of a lens used in the light emitting device of Example 1;

FIG. 12B is a graph (of Table 1) illustrating a relationship between R and sagB, which indicates the incident surface shape of the lens used in the light emitting device of Example 1;

FIG. 13 is a graph illustrating an illuminance distribution of the light emitting device of Example 1;

FIG. 14 is a graph illustrating an illuminance distribution when a surface light source is constructed by an LED in order to look at an effect of the light emitting device of Example 1;

FIG. 15 is a graph illustrating an illuminance distribution of a light emitting device having the same configuration as Example 1 except that an incident surface of a lens is rotationally symmetrical;

FIG. 16 is a graph illustrating a distribution of a Y value of the chromaticity of Example 1;

FIG. 17 is a graph illustrating a distribution of a Y value of the chromaticity of a light emitting device having the same configuration as Example 1 except that the incident surface of the lens is rotationally symmetrical;

FIG. 18 is a light path diagram of the light emitting device of Example 1;

FIG. 19 is a graph illustrating an illuminance distribution of a surface light source of Example 1; and

FIG. 20 is a graph illustrating an illuminance distribution only of the light source.

### DETAILED DESCRIPTION

Hereinafter, embodiments of the disclosure will be described in detail with reference to the drawings. However, the detailed description beyond necessity is occasionally omitted. For example, the detailed description of a well-known item and the detailed description of a substantially identical configuration are occasionally omitted. Therefore, the unnecessarily redundant description is avoided for the purpose of easy understanding of those skilled in the art.

The inventors provide the accompanying drawings and the following description in order that those skilled in the art sufficiently understand the disclosure, however, the scope defined by the appended claims is not limited by the accompanying drawings and the following description.

### First Embodiment

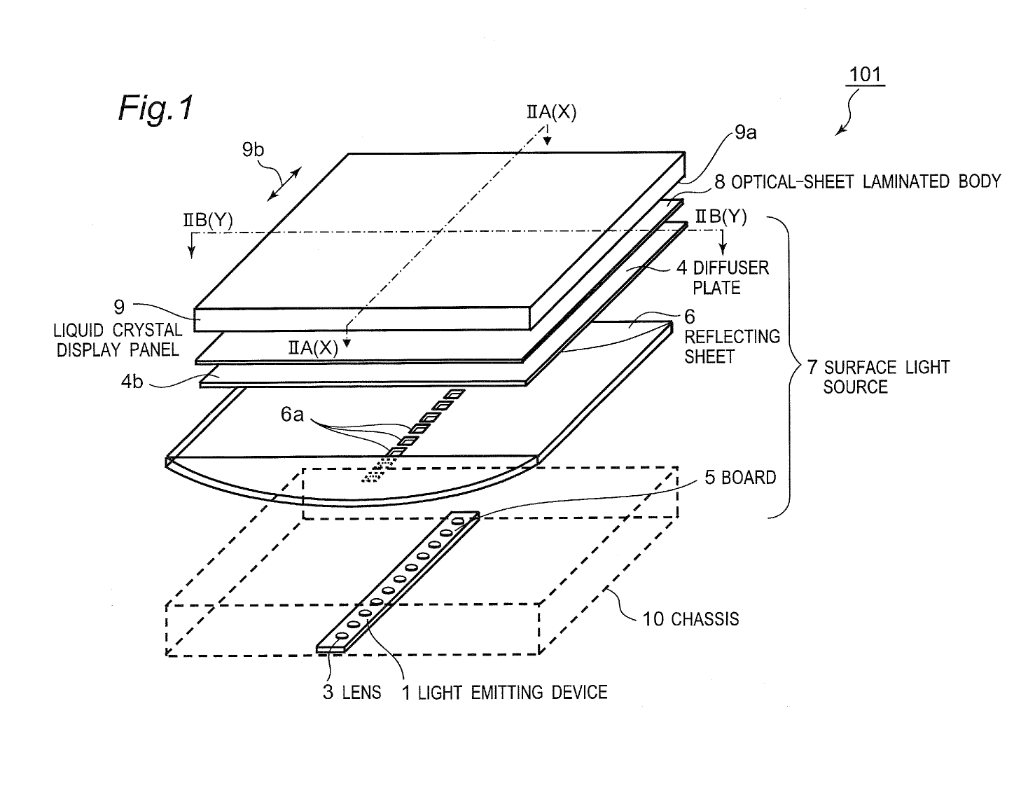

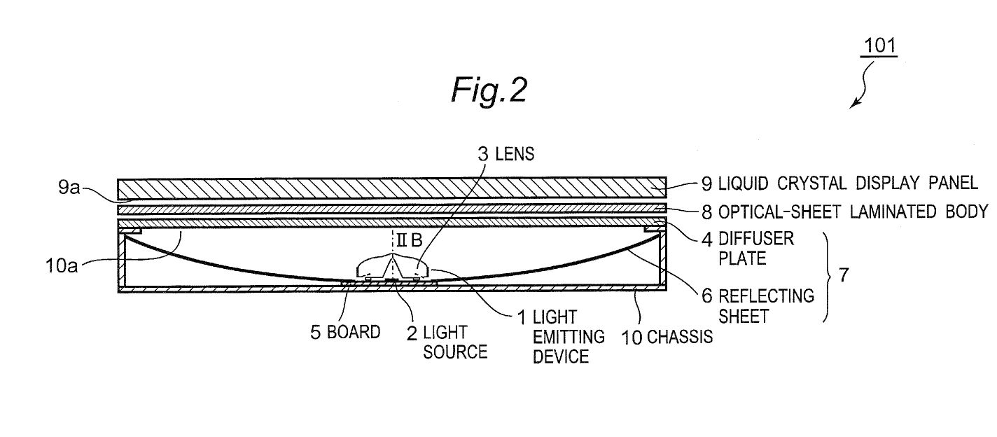

FIG. 1 is an exploded perspective view illustrating a whole schematic configuration of a liquid crystal display device 101 according to a first embodiment of the disclosure. FIG. 2 is a cross-sectional view taken on a line IIA(X)-IIA(X) of FIG. 1.

As illustrated in FIGS. 1 and 2, the liquid crystal display device 101 includes a transmissive liquid crystal display panel 9 having a rectangular flat-plate shape, and a surface light source 7 with a rectangular parallelepiped shape which is disposed at a side of a back surface 9a (a non-display surface side) of the liquid crystal display panel 9 and has a size corresponding to the liquid crystal display panel 9. The surface light source 7 acts as a backlight of the liquid crystal display panel 9, and an LED is used as a light source of the surface light source 7.

The surface light source 7 includes a plurality of light emitting devices 1 that are linearly disposed along a long-side direction 9b of the liquid crystal display panel 9 so as to be faced to a central portion of the liquid crystal display panel 9, a rectangular parallelepiped chassis 10 that accommodates the light emitting devices 1 therein, a diffuser plate 4 that is disposed between the liquid crystal display panel 9 and the light emitting devices 1 so as to cover an aperture 10a of the chassis 10, and a reflecting sheet 6 that is disposed in the chassis 10 to reflect light emitted from the light emitting device 1 onto the side of the back surface 9a of the liquid crystal display panel 9, namely, the side of the diffuser plate 4. The diffuser plate 4 extends while being orthogonal to an optical axis of the light emitting device 1. In the first embodiment, the reflecting sheet 6 is constructed by a circular arc sheet material having continuously provided reflecting faces that are curved along the long-side direction 9b of the liquid crystal display panel 9, and has side plates that warp to the outside of the surface light source 7, the side plates being provided in both end portions in the long-side direction 9b. The reflecting sheet 6 also has a circular arc or tilt shape along a short-side direction. The shape of the reflecting sheet 6 is not limited to the circular arc shape of the first embodiment. As described in detail later, the light emitting device 1 includes an LED light source 2 and a lens 3 that is disposed so as to cover the light source 2.

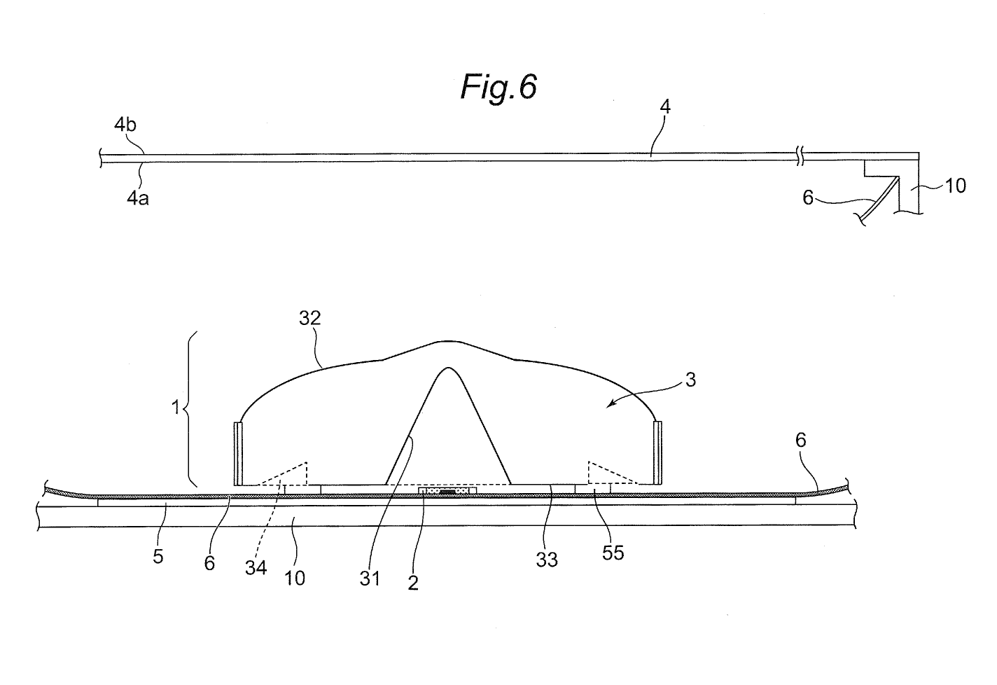

The diffuser plate 4 includes an optical-sheet laminated body 8 having a size equivalent to the liquid crystal display panel 9 on a radiation surface 4b (see FIG. 6), which is disposed opposite to the back surface 9a of the liquid crystal display panel 9, namely a surface that emits light. An irradiated surface 4a (see FIG. 6) of the diffuser plate 4, which is disposed opposite to the radiation surface 4b, is irradiated with the light from the light emitting device 1. For example, the optical-sheet laminated body 8 is constructed by a prism sheet that collects the light incident from the diffuser plate 4 toward the side of the liquid crystal display panel 9 in front of the body 8, a diffusion sheet that additionally diffuses the light incident from the diffuser plate 4, a polarizing sheet that transmits the light having a specific polarization plane such that the polarization plane of the incident light corresponds to the polarization plane of the liquid crystal display panel 9, and the like. In the first embodiment, the light emitting devices 1 are linearly disposed opposite to the central portion of the liquid crystal display panel 9, whereby the light emitting devices 1 are disposed in the substantially central portion of the surface light source 7.

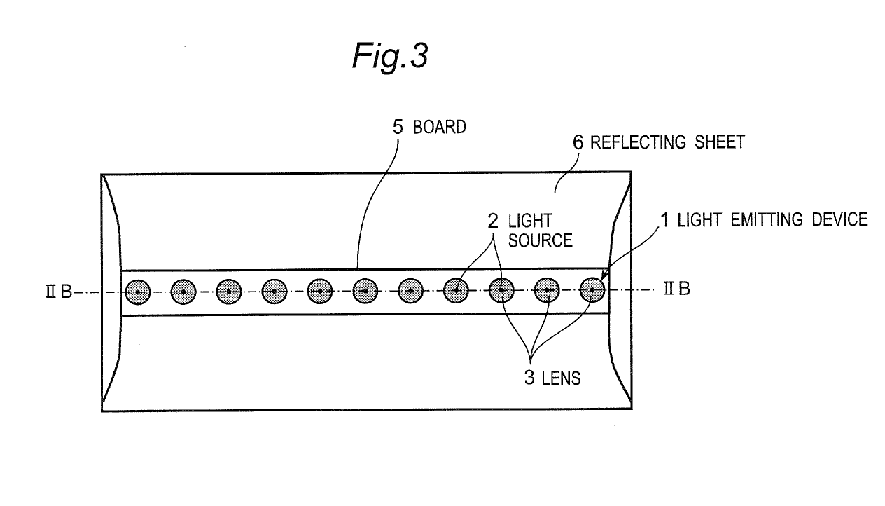

FIG. 3 is a plan view illustrating the light emitting device 1 of the surface light source 7.

The light emitting devices 1 are disposed at predetermined intervals on a surface of a strip-shaped, insulating board 5 on which a predetermined wiring pattern is formed at a rear surface side.

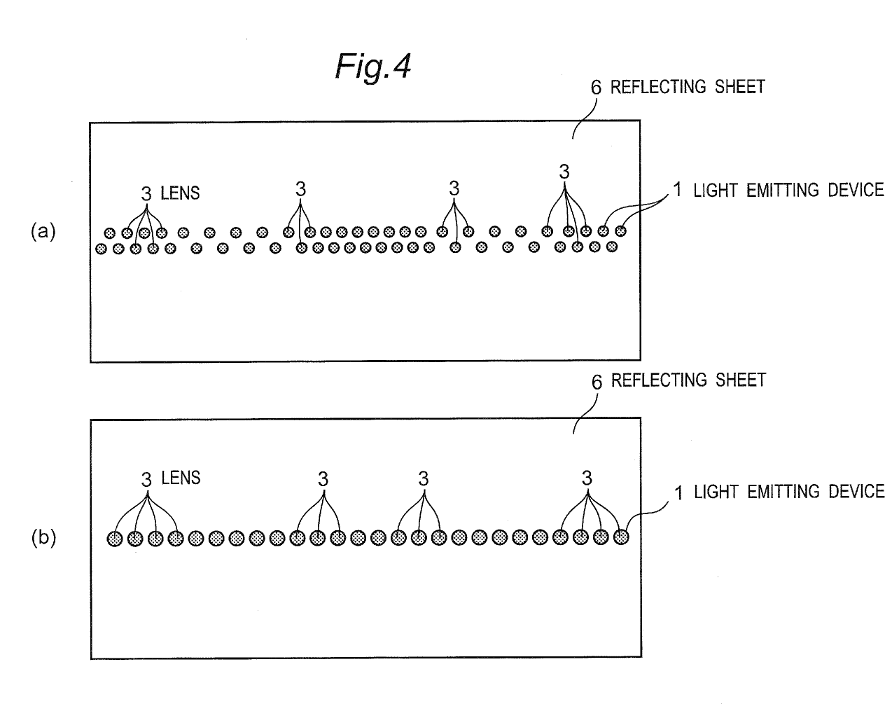

In the first embodiment, as illustrated in (a) of FIG. 4, the plurality of light emitting devices 1 are linearly disposed in two lines along the long-side direction 9b in the central portions of the liquid crystal display panel 9 and the diffuser plate 4. In the (a) of FIG. 4, the plurality of light emitting devices 1 are arrayed in a zigzag manner in the lines adjacent to each other. Alternatively, the light emitting devices 1 may be arrayed not in the zigzag manner, but at the same position in the lines adjacent to each other. As to the number of arrayed lines, the light emitting devices 1 may be arrayed in one (see (b) of FIG. 4) or three lines as long as the light emitting devices 1 are linearly arrayed in central portion.

In the surface light source 7, as mentioned above, when the plurality of light emitting devices 1 are linearly arrayed in central portion, luminance distributions of lens arrays overlap each other, allowing reduction of unevenness of the luminance distribution. Additionally, when the light emitting devices 1 are linearly arrayed in central portion, brightness is sufficiently ensured as the surface light source 7, and the surface light source 7 can be constructed by few light sources 2 and lenses 3 thereby resulting in a low cost of the surface light source 7.

Based on experiments performed by the inventors, when the plurality of light emitting devices 1 are linearly arrayed in one line so as to be opposite to the central portion of the liquid crystal display panel 9, a small amount of light may be output from the diffuser plate 4 and then the sufficient brightness at end portions of the surface light source may not be ensure. In such a case, a large-output light source 2 can be used, however it makes the cost increase. On the other hand, in the liquid crystal display device 101, it is necessary that the central portion of the screen be brighter than a peripheral portion. Therefore, a disposition pitch of the light emitting devices 1 is not kept constant, but the light emitting devices 1 are optionally disposed so as to become dense, coarse, and dense from the central portion toward the peripheral portion. Accordingly, such disposition can construct the surface light source 7 having the low-unevenness luminance distribution in which the necessary brightness is ensured to the end portions while ensuring the sufficient brightness in the central portion of the screen.

In the LED light source 2, a light emitting element emitting blue light is sealed by a fluorescent material of a YAG-based and/or a TAG-based, etc., thereby generating pseudo-white light. Therefore, at this time, the LED light source that emits light having an even color in all the directions is rarely used from the viewpoint of cost. Accordingly, color unevenness is generated. However, An X-direction having a large difference of a light emitting region between the different colors is aligned with the direction in which the light emitting devices 1 are linearly arrayed to increase overlapping of the unevenly-colored portions, so that the color unevenness can maintain inconspicuous in the surface light source 7. Additionally, a direction in which the lens 3 has a weak refractive power is also aligned with the linearly-arrayed direction, so that not only the color unevenness is suppressed but also the necessary brightness can be ensured in the end portions of the surface light source 7. The problem of the color unevenness mentioned above is caused by the configuration in which the light emitting devices 1 are arrayed in line at the central portion of the surface light source 7 like the first embodiment. On the other hand, the problem of the above color unevenness is not generated in the conventional backlight because in the conventional backlight, a light source and a light guide plate are disposed at a lateral edge of the liquid crystal display panel, so that the light is diffused by the light guide plate.

The light source 2 and the lens 3, which constitute the light emitting device 1, are described in detail later in a third embodiment.

### Second Embodiment

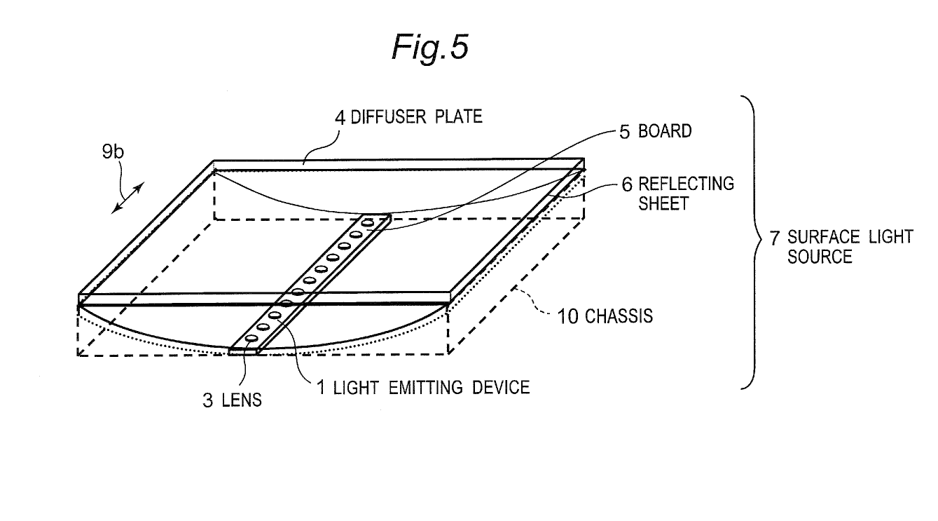

The surface light source 7 according to a second embodiment of the disclosure will be described in detail. FIG. 5 is a configuration diagram of the surface light source 7. As described in the first embodiment, the surface light source 7 includes the plurality of light emitting devices 1, each of which includes the light source 2 and the lens 3 and is arrayed in line along the long-side direction 9b while being opposite to the central portion of the liquid crystal display panel 9, and the diffuser plate 4 that is disposed so as to cover the light emitting devices 1. As described above, the light source 2 and the lens 3, which constitute the light emitting device 1, are described in detail later in a third embodiment.

As illustrated in FIG. 6, the surface light source 7 includes the board 5 that is disposed opposite to the diffuser plate 4 with the light emitting device 1 interposed therebetween. On the board 5, the LED light source 2 of each light emitting device 1 is mounted. The lens 3 is placed on the board 5 while covering the light source 2. In the second embodiment, a bottom surface 33 of the lens 3 is bonded to the board 5 with support posts 55 interposed therebetween. Further, the reflecting sheet 6 is disposed between the board 5 and the diffuser plate 4 such that the reflecting sheet 6 covers the board 5 while avoiding the light source 2, namely, such that the reflecting sheet 6 covers the board 5 while exposing the light source 2. Alternatively, a reflecting coating may be provided on the board 5 instead of the reflecting sheet 6. The reflecting sheet 6 and the reflecting coating correspond to an example of the reflecting member. As illustrated in FIG. 1, a window 6a is formed according to each light emitting device 1 in the reflecting sheet 6. It is not always necessary that the bottom surface 33 of the lens 3 be bonded to the board 5 with the support posts 55 interposed therebetween, but the bottom surface 33 may directly be bonded to the board 5. The support posts 55 may be formed while being integral with the lens 3.

The light emitting device 1 irradiates the irradiated surface 4a of the diffuser plate 4 with the light. The diffuser plate 4 diffuses light irradiated to the irradiated surface 4a and then radiates the light from the radiation surface 4b. Each light emitting device 1 emits the light such that a wide range of the irradiated surface 4a of the diffuser plate 4 has the even illuminance, and the light is diffused by the diffuser plate 4, allowing the construction of the surface light source 7 in which a small amount of luminance unevenness is generated.

The light from the light emitting device 1 is diffused by the diffuser plate 4 to return to the side of the light emitting device 1 and/or to be transmitted through the diffuser plate 4. The light, which returns to the side of light emitting devices 1 to impinge on the reflecting sheet 6, is reflected by the reflecting sheet 6 and enters to the diffuser plate 4 again.

### Third Embodiment

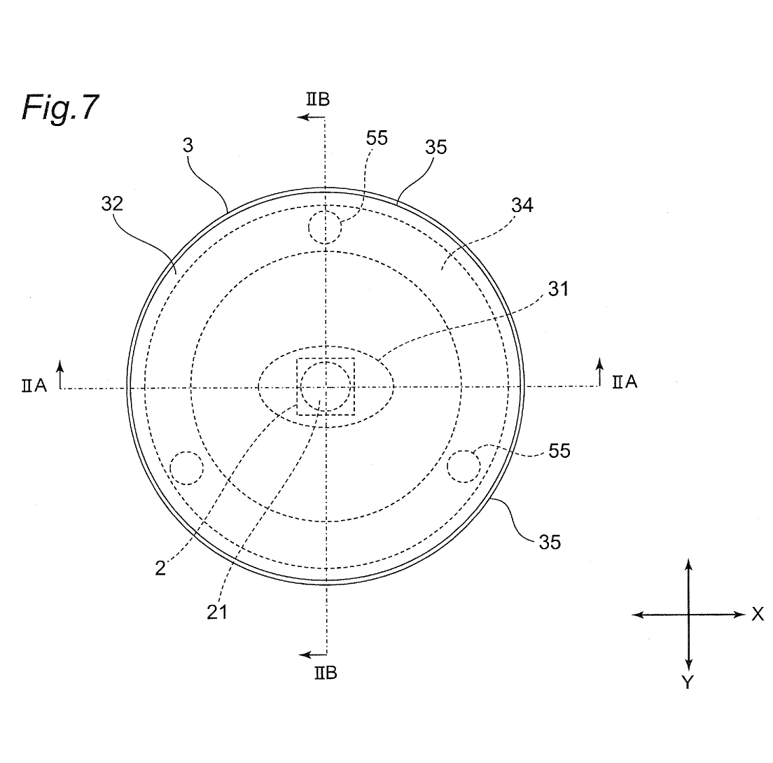

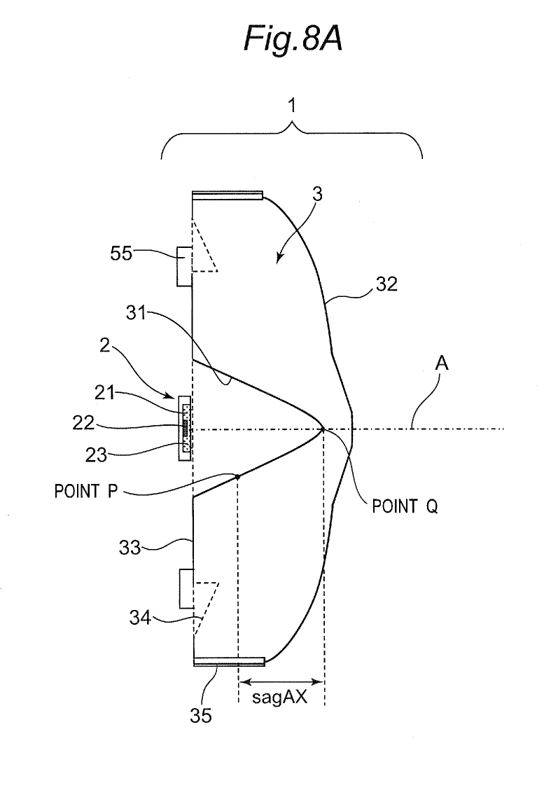

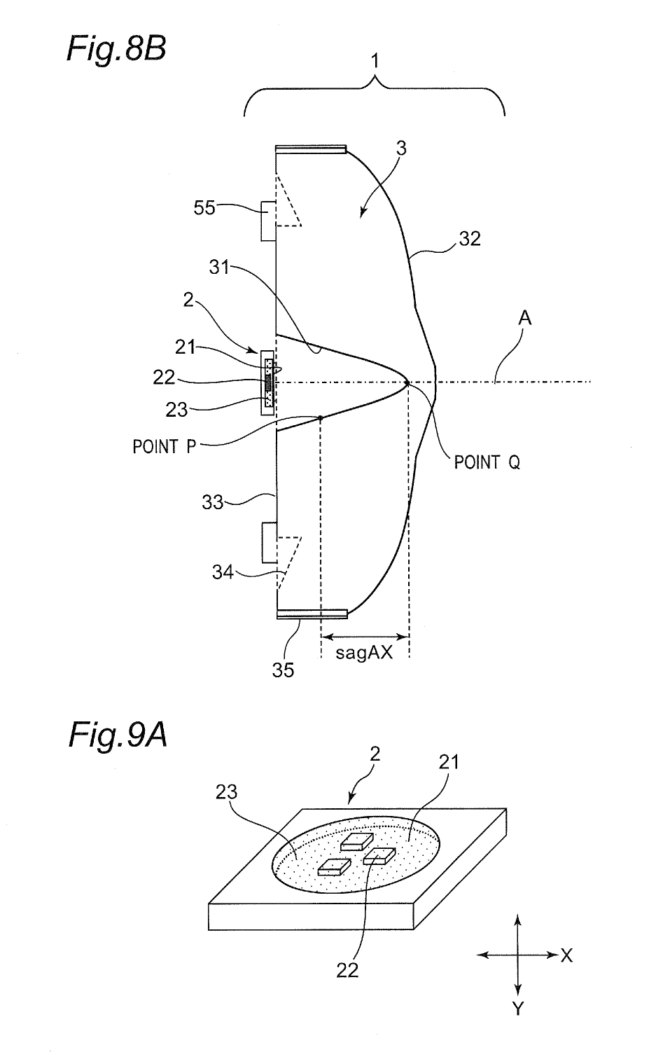

The light emitting device 1 according to a third embodiment of the disclosure will be described in detail. FIGS. 7, 8A, and 8B are views illustrating a configuration of the light emitting device 1. As described above, the light emitting device 1 includes the light source 2 and the lens 3 that radially expands the light emitted from the light source 2. For example, the light emitting device 1 radiates light onto the irradiated surface 4a of the diffuser plate 4 at an optical axis A and at the substantially circular shape around the optical axis A. That is, directionality of the light emitted from the light source 2 is expanded by the lens 3, whereby the wide range of the irradiated surface 4a of the diffuser plate 4 is illuminated at the optical axis A and around the optical axis A. The illuminance distribution on the irradiated surface 4a becomes the maximum at the optical axis A, and is monotonously decreased toward a surrounding region from the optical axis A.

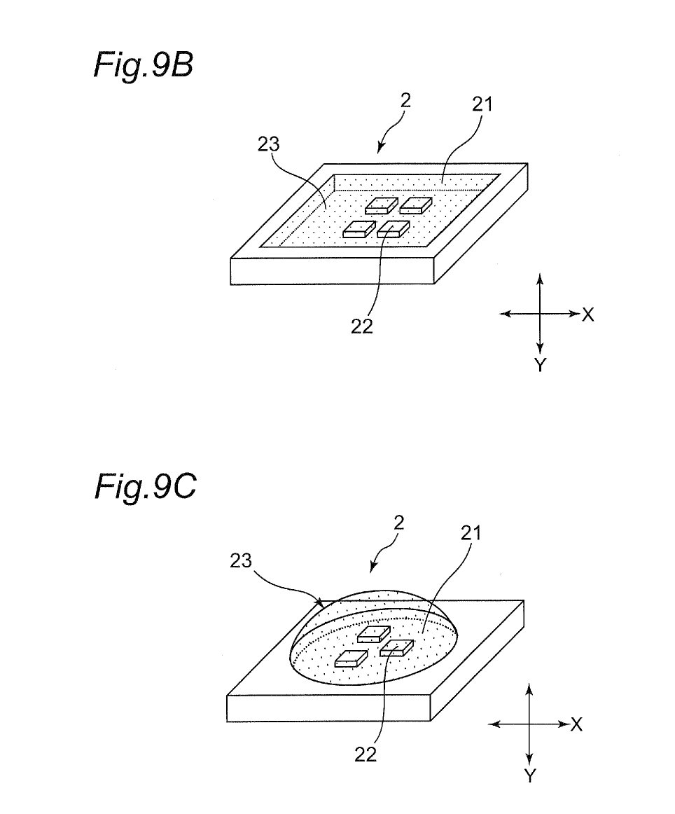

An LED formed as follows is adopted as the light source 2 in the third embodiment. Namely, a light emitting element 22 is bonded onto a board and is sealed by a transparent resin 23 into which the fluorescent materials dispersed. The transparent resin 23 corresponds to the fluorescent layer. A flat surface of the LED becomes an emission surface 21. For example, the emission surface 21 may be formed into a circular shape as illustrated in FIG. 9A, or formed into a rectangular shape as illustrated in FIG. 9B. As illustrated in FIG. 9C, the light source 2 may be constructed by the light emitting element 22 and the dome-shaped transparent resin 23, which is formed on the light emitting element 22 and in which the fluorescent materials are dispersed, and the emission surface 21 may be constructed by a three-dimensional surface of the transparent resin 23.

The number of light emitting elements 22 used as the light source 2 may vary depending on a kind of the light source. At this point, the light emitting elements 22 may not be disposed in the rotationally symmetrical manner. For the sake of convenience, the emission surface 21 includes a first direction orthogonal to the optical axis and a second direction orthogonal to the optical axis and the first direction, and the first direction is set to the X-direction while the second direction is set to the Y-direction.

As described in the first embodiment, the light radiated from the emission surface 21 of the light source 2 is the pseudo-white light made by the blue light emitted by the light emitting element 22 and the yellow light from the fluorescent material excited by the blue light. Therefore, there is generated a difference in emission areas between the blue light and the yellow light in a near field. Additionally, a light distribution changes based on the disposition of the light emitting element 22. Therefore, in the case the light distribution has anisotropy according to the disposition of the light emitting element, the light distribution having the larger difference in emission areas between the blue light and the yellow light is defined as the X-direction, and the light distribution having the smaller difference is defined as the Y-direction, for the sake of convenience.

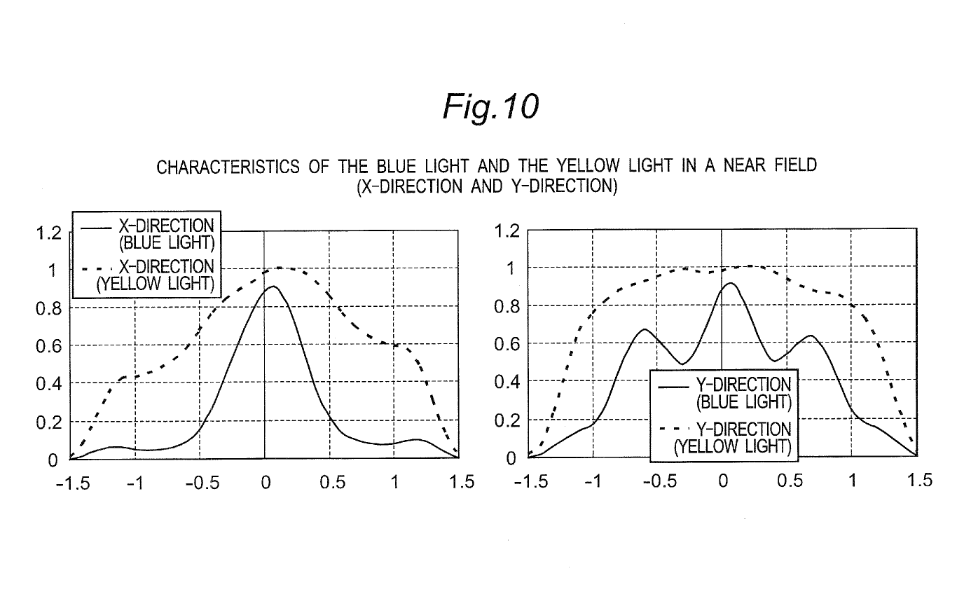

FIG. 10 illustrates a luminance distribution on a line extending in the X-direction through the optical axis A in the emission surface 21 of the light source 2 and a luminance distribution on a line extending in the Y-direction through the optical axis A in each color of the lights. In FIG. 10, a vertical axis indicates the illuminance normalized by the maximum value, and a horizontal axis indicates the distance (mm) from the optical axis. As illustrated in FIG. 10, the yellow light differs from the blue light in a range of the luminance distribution on the emission surface 21. Specifically, the luminance distribution of the yellow light is wider than that of the blue light. Thus, the luminance distribution of the light radiated from the light source 2 varies according to the color of the light. Therefore, in the case that the light emitting device 1 that generates the pseudo-white light is used like the third embodiment, it is necessary to reduce the color unevenness.

The lens 3 is made of a transparent material having a predetermined refractive index. For example, the refractive index of the transparent material ranges from about 1.4 to about 2.0. Examples of the transparent material include resins, such as an epoxy resin, a silicone resin, an acrylic resin, and polycarbonate, glass, and rubbers, such as a silicone rubber. Among others, the epoxy resin or the silicone rubber, which are conventionally used as an LED sealing resin, can be used for the lens 3.

Specifically, as illustrated in FIG. 8A, the lens 3 includes an incident surface 31 through which the light from the light source 2 is entered into the lens 3 and an output surface 32 from which the light incident to the lens 3 is output. A maximum outer diameter of the output surface 32 defines an effective diameter of the lens 3. The lens 3 also has the bottom surface 33. The bottom surface 33 is located around the incident surface 31, and located on the opposite side to the output surface 32 in the optical axis direction. A reflection unit 34, which is formed into a circular or elliptical shape around the optical axis A as a center position, is provided in the bottom surface 33. In the third embodiment, a ring 35 is provided between the output surface 32 and the bottom surface 33 so as to overhang the outside in the diametrical direction. The ring 35 has a substantial U-shape in section, and an outer circumferential edge of the output surface 32 and an outer circumferential edge of the bottom surface 33 are coupled by the ring 35. However, the ring 35 may be eliminated, and the outer circumferential edge of the output surface 32 and the outer circumferential edge of the bottom surface 33 may be coupled by an end surface having a linear shape or a circular arc shape in section. The components of the lens 3 will further be described in detail below.

In the third embodiment, the incident surface 31 is a continuously concave surface. The light source 2 is disposed away from the incident surface 31 of the lens 3. In the third embodiment, the output surface 32 is a continuously convex surface that is rotationally symmetrical with respect to the optical axis A. For example, the ring-like bottom surface 33 surrounding the incident surface 31 is flat. In the third embodiment, the emission surface 21 of the light source 2 is substantially in the same level as the flat bottom surface 33 in the optical axis direction in which the optical axis A extends.

After the light from the light source 2 is entered into the lens 3 through the incident surface 31, the light is output from the output surface 32 and reaches, for example, the irradiated surface 4a of the diffuser plate 4 as described above. The light emitted from the light source 2 is extended by refraction actions of the incident surface 31 and the output surface 32, and reaches the wide range of the irradiated surface 4a.

Further, the lens 3 plays a role in reducing the color unevenness on the irradiated surface 4a, which is generated by the blue light and the yellow light radiated from light source 2 with the different emission areas. In order to implement the role, the lens 3 is configured such that the refractive power in the X-direction differs from the refractive power in the Y-direction. In the third embodiment, the incident surface 31 includes an anamorphic curved surface in which the X-direction differs from the Y-direction in a configuration of curvature, whereby the refractive power in the X-direction differs from the refractive power in the Y-direction.

As described above, in the third embodiment, the incident surface 31 is configured to include the anamorphic curved surface. Alternatively, the output surface 32 may be configured to include the anamorphic curved surface. That is, at least one of the incident surface 31 and the output surface 32 may be configured to include the anamorphic curved surface.

At this point, it is noted that the refractive power does not mean a concept of a lens “power” that is generally used in design of an optical system and/or design of an imaging system, namely, does not mean that a curvature of the lens varies near the optical axis in the case of an aspherical lens. As used herein the “refractive power” means a concept in which, at least one of the incident surface 31 and the output surface 32 has a shape equivalent to a surface of a spheroid, and the cross-sectional shape orthogonal to the optical axis A has the elliptical shape at any position in the optical axis direction. In other words, the X-direction differs from the Y-direction in a distance from the optical axis A of the cross-sectional shape orthogonal to the optical axis A, or the X-direction differs from the Y-direction in the direction in which the light is emitted from the incident surface 31 and the output surface 32 even when the light from the light source 2 has the same angle of incident at the incident surface 31 and the output surface 32, namely, a light distribution direction is different in the X-direction and the Y-direction. Hereinafter the curved surface having the above configuration is referred to as “anamorphic”.

Particularly, as illustrated in FIGS. 8A and 8B, the incident surface 31 has a vertex Q on the optical axis A. Assuming that a sag amount (as to a sign, from a vertex Q toward the side of the light source 2 is negative, and the opposite side to the light source 2 from the vertex Q is positive) is a distance along the optical axis A from the vertex Q to a point P (that is, a distance in the optical axis direction) on the incident surface 31, the incident surface 31 has a shape in which a sag amount sagAX in the X-direction differs from a sag amount sagAY in the Y-direction at the same positions located at the distance R radially away from the optical axis A (that is, on a concyclic point about the optical axis A). The incident surface 31 may extend toward the side of the light source 2, after the incident surface 31 retreats from the vertex Q toward the opposite side to the light source 2 such that the sag amount becomes positive near the optical axis A.

According to the light emitting device 1 having the above configuration, the color unevenness generated by the light source 2 is reduced by the lens 3. Accordingly, although the relatively small lens 3 is used, the light can be radiated while the color unevenness that is a characteristic of the light source 2 is reduced.

As described in the first embodiment, in order to reduce the color unevenness, the direction in which the light emitting devices 1 are arrayed may be aligned with the direction in which the lens 3 has the weak refractive power. When the description of the first embodiment is replaced with the meaning of the above “refractive power”, the direction in which the lens 3 has the weak refractive power corresponds to a direction which is orthogonal to the optical axis and in which the distance from the optical axis is longer in a sectional shape of the lens 3. The sectional shape of the lens 3 is equivalent to the sectional shape of at least one of the incident surface 31 and the output surface 32. Further, as described in the first embodiment, in order to reduce the color unevenness, the direction of the larger difference in emission areas between the different colors may be aligned with the direction in which the light emitting devices 1 are arrayed. When the description of the first embodiment is replaced with the meaning of the above “refractive power”, it is said that the direction of the larger difference in emission areas between the different colors may be aligned with or substantially aligned with the direction in which the distance from the optical axis is longer in the sectional shape of the lens 3.

### EXAMPLE 1

The light emitting device 1 of Example 1 will be described below as a specific numerical example of the disclosure.

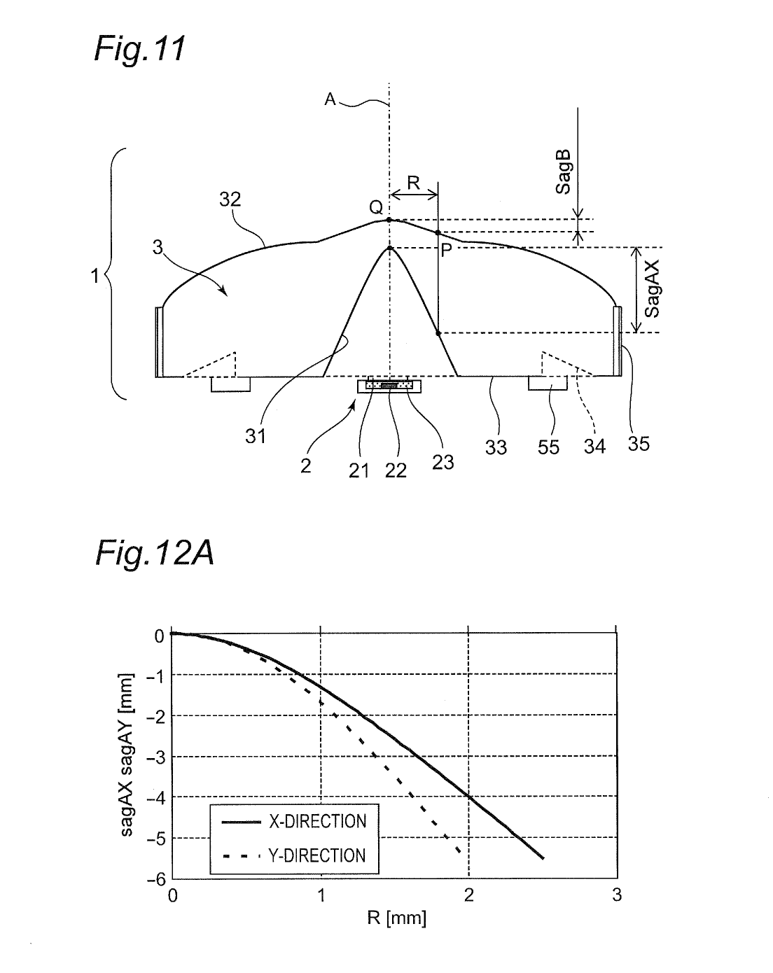

FIG. 11 is a cross-sectional view of the light emitting device 1 of Example 1. The lens 3, in which the whole surface of the incident surface 31 is the anamorphic curved surface while the output surface 32 is rotationally symmetrical, is used in Example 1.

In FIG. 11, the numerals Q, P, and sagAX (sagAY) are identical to those in FIGS. 8A and 8B. In FIG. 11, the numeral sagB designates a sag amount of the output surface 32 at the position located the distance R away from the optical axis A.

### EXAMPLE 1

In Example 1, the general-purpose LED in which the emission surface 21 has a size of about φ3.0 mm is used as the light source 2 in order that the directionality of the light from the light source 2 is expanded to suppress the color unevenness. In Example the lens 3 has an effective diameter of 20.7 mm. The lens has a thickness of 1.2 mm in the center of the optical axis. Table 1 illustrates specific numerical values of Example 1.

TABLE 1

| | | | | X- or | |
|---|---|---|---|---|---|
| X-axis | SagAX | Y-axis | SagAY | Y-axis | SagB |
| 0.00 | 0.000 | 0.00 | 0.000 | 0.00 | 0.000 |
| 0.05 | −0.004 | 0.05 | −0.005 | 0.10 | 0.000 |
| 0.10 | −0.016 | 0.10 | −0.018 | 0.20 | −0.001 |
| 0.15 | −0.035 | 0.15 | −0.042 | 0.30 | −0.002 |
| 0.20 | −0.062 | 0.20 | −0.074 | 0.40 | −0.004 |
| 0.25 | −0.096 | 0.25 | −0.115 | 0.50 | −0.007 |
| 0.30 | −0.138 | 0.30 | −0.165 | 0.60 | −0.013 |
| 0.35 | −0.187 | 0.35 | −0.224 | 0.70 | −0.019 |
| 0.40 | −0.242 | 0.40 | −0.292 | 0.80 | −0.028 |
| 0.45 | −0.303 | 0.45 | −0.367 | 0.90 | −0.038 |
| 0.50 | −0.371 | 0.50 | −0.452 | 1.00 | −0.050 |
| 0.55 | −0.445 | 0.55 | −0.544 | 1.10 | −0.064 |
| 0.60 | −0.524 | 0.60 | −0.644 | 1.20 | −0.079 |
| 0.65 | −0.608 | 0.65 | −0.751 | 1.30 | −0.096 |
| 0.70 | −0.697 | 0.70 | −0.866 | 1.40 | −0.114 |
| 0.75 | −0.791 | 0.75 | −0.987 | 1.50 | −0.132 |
| 0.80 | −0.889 | 0.80 | −1.116 | 1.60 | −0.152 |
| 0.85 | −0.991 | 0.85 | −1.251 | 1.70 | −0.173 |
| 0.90 | −1.097 | 0.90 | −1.392 | 1.80 | −0.193 |
| 0.95 | −1.206 | 0.95 | −1.540 | 1.90 | −0.214 |
| 1.00 | −1.318 | 1.00 | −1.693 | 2.00 | −0.235 |
| 1.05 | −1.434 | 1.05 | −1.851 | 2.10 | −0.256 |
| 1.10 | −1.552 | 1.10 | −2.015 | 2.20 | −0.277 |
| 1.15 | −1.673 | 1.15 | −2.184 | 2.30 | −0.297 |
| 1.20 | −1.796 | 1.20 | −2.358 | 2.40 | −0.317 |
| 1.25 | −1.922 | 1.25 | −2.536 | 2.50 | −0.336 |
| 1.30 | −2.050 | 1.30 | −2.719 | 2.60 | −0.354 |
| 1.35 | −2.180 | 1.35 | −2.906 | 2.70 | −0.371 |
| 1.40 | −2.311 | 1.40 | −3.097 | 2.80 | −0.388 |
| 1.45 | −2.445 | 1.45 | −3.292 | 2.90 | −0.405 |
| 1.50 | −2.580 | 1.50 | −3.490 | 3.00 | −0.420 |
| 1.55 | −2.716 | 1.55 | −3.692 | 3.10 | −0.435 |
| 1.60 | −2.854 | 1.60 | −3.897 | 3.20 | −0.449 |
| 1.65 | −2.994 | 1.65 | −4.105 | 3.30 | −0.463 |
| 1.70 | −3.134 | 1.70 | −4.317 | 3.40 | −0.476 |
| 1.75 | −3.276 | 1.75 | −4.531 | 3.50 | −0.488 |
| 1.80 | −3.419 | 1.80 | −4.748 | 3.60 | −0.501 |
| 1.85 | −3.563 | 1.85 | −4.967 | 3.70 | −0.513 |
| 1.90 | −3.708 | 1.90 | −5.189 | 3.80 | −0.525 |
| 1.95 | −3.853 | 1.95 | −5.414 | 3.90 | −0.536 |
| 2.00 | −4.000 | 1.97 | −5.500 | 4.00 | −0.547 |
| 2.05 | −4.147 | | | 4.10 | −0.559 |
| 2.10 | −4.296 | | | 4.20 | −0.570 |
| 2.15 | −4.445 | | | 4.30 | −0.581 |
| 2.20 | −4.594 | | | 4.40 | −0.593 |
| 2.25 | −4.745 | | | 4.50 | −0.604 |
| 2.30 | −4.895 | | | 4.60 | −0.616 |
| 2.35 | −5.047 | | | 4.70 | −0.628 |
| 2.40 | −5.199 | | | 4.80 | −0.640 |
| 2.50 | −5.500 | | | 4.90 | −0.653 |
| | | | | 5.00 | −0.666 |
| | | | | 5.10 | −0.680 |
| | | | | 5.20 | −0.694 |
| | | | | 5.30 | −0.709 |
| | | | | 5.40 | −0.724 |
| | | | | 5.50 | −0.741 |
| | | | | 5.60 | −0.759 |
| | | | | 5.70 | −0.777 |
| | | | | 5.80 | −0.797 |
| | | | | 5.90 | −0.818 |
| | | | | 6.00 | −0.840 |
| | | | | 6.10 | −0.863 |
| | | | | 6.20 | −0.888 |
| | | | | 6.30 | −0.914 |
| | | | | 6.40 | −0.941 |
| | | | | 6.50 | −0.970 |
| | | | | 6.60 | −0.999 |
| | | | | 6.70 | −1.030 |
| | | | | 6.80 | −1.062 |
| | | | | 6.90 | −1.095 |
| | | | | 7.00 | −1.129 |
| | | | | 7.10 | −1.164 |
| | | | | 7.20 | −1.200 |
| | | | | 7.30 | −1.237 |
| | | | | 7.40 | −1.275 |
| | | | | 7.50 | −1.313 |
| | | | | 7.60 | −1.353 |
| | | | | 7.70 | −1.394 |
| | | | | 7.80 | −1.437 |
| | | | | 7.90 | −1.481 |
| | | | | 8.00 | −1.526 |
| | | | | 8.10 | −1.574 |
| | | | | 8.20 | −1.624 |
| | | | | 8.30 | −1.676 |
| | | | | 8.40 | −1.731 |
| | | | | 8.50 | −1.788 |
| | | | | 8.60 | −1.848 |
| | | | | 8.70 | −1.911 |
| | | | | 8.80 | −1.977 |
| | | | | 8.90 | −2.045 |
| | | | | 9.00 | −2.116 |
| | | | | 9.10 | −2.190 |
| | | | | 9.20 | −2.268 |
| | | | | 9.30 | −2.349 |
| | | | | 9.40 | −2.435 |
| | | | | 9.50 | −2.528 |
| | | | | 9.60 | −2.629 |
| | | | | 9.70 | −2.741 |
| | | | | 9.80 | −2.866 |
| | | | | 9.90 | −3.006 |
| | | | | 10.00 | −3.165 |
| | | | | 10.10 | −3.340 |
| | | | | 10.20 | −3.530 |
| | | | | 10.30 | −3.725 |
| | | | | 10.35 | −3.819 |

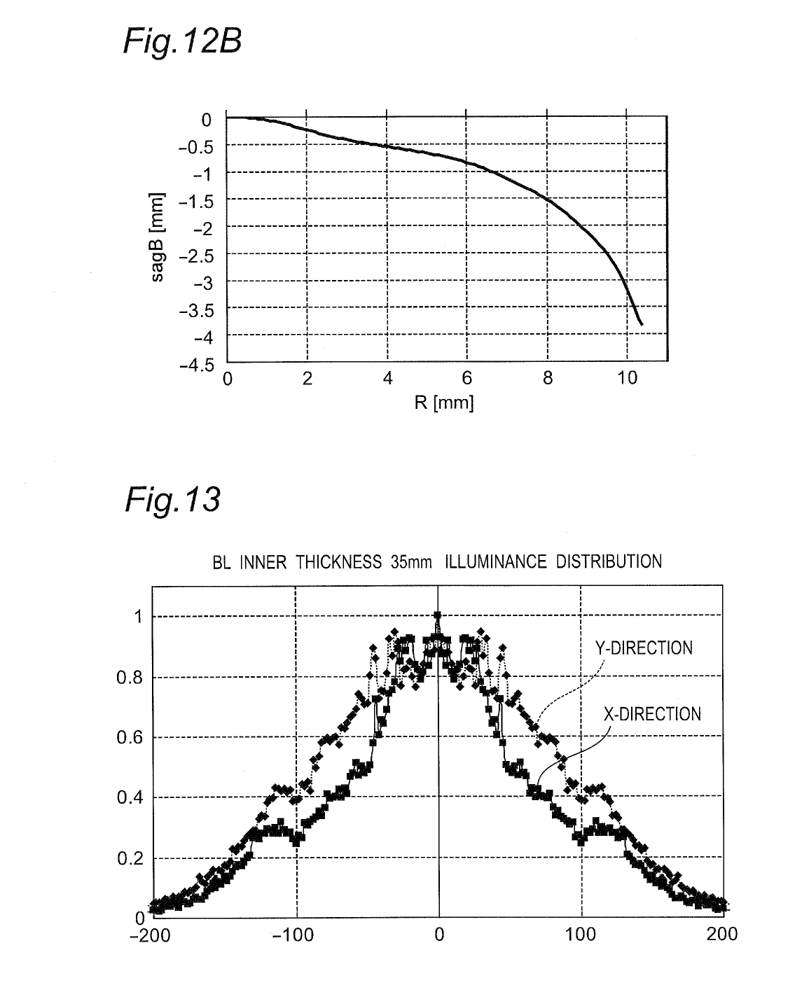

FIG. 12A is a graph illustrating values (R) of an X-axis and a Y-axis, and sagAX and sagAY in Table 1, and FIG. 12B is a graph illustrating the values (R) of the X-axis and the Y-axis, and sagB.

FIG. 13 illustrates an illuminance distribution on the irradiated surface 4a of the diffuser plate 4 when the irradiated surface 4a is disposed at the position 35 mm away from the emission surface 21 of the light source 2 in the optical axis direction using the light emitting device 1 of Example 1. In FIG. 13, a vertical axis indicates the illuminance normalized by the maximum value, and a horizontal axis indicates the distance (mm) from the optical axis.

FIG. 14 illustrates an illuminance distribution when a surface light source is constructed only by the LED with no use of the lens 3 in order to check the effect of the light emitting device 1 of Example 1.

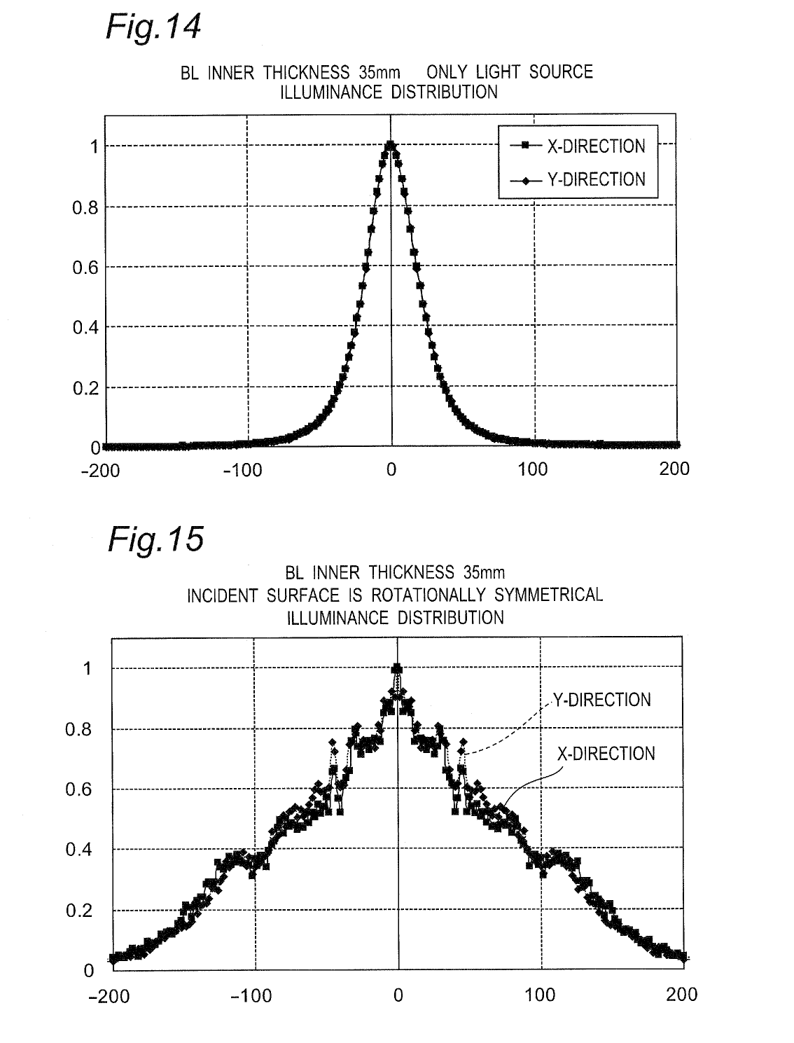

FIG. 15 illustrates an illuminance distribution on the irradiated surface 4a of the diffuser plate 4 in a case that an incident surface 31 of the lens 3 is constructed by a curved surface that is rotationally symmetrical with respect to the optical axis when the irradiated surface 4a is disposed at the position 35 mm away from the emission surface 21 of the light source 2 in the optical axis direction using a light emitting device having a configuration corresponding to that of Example 1.

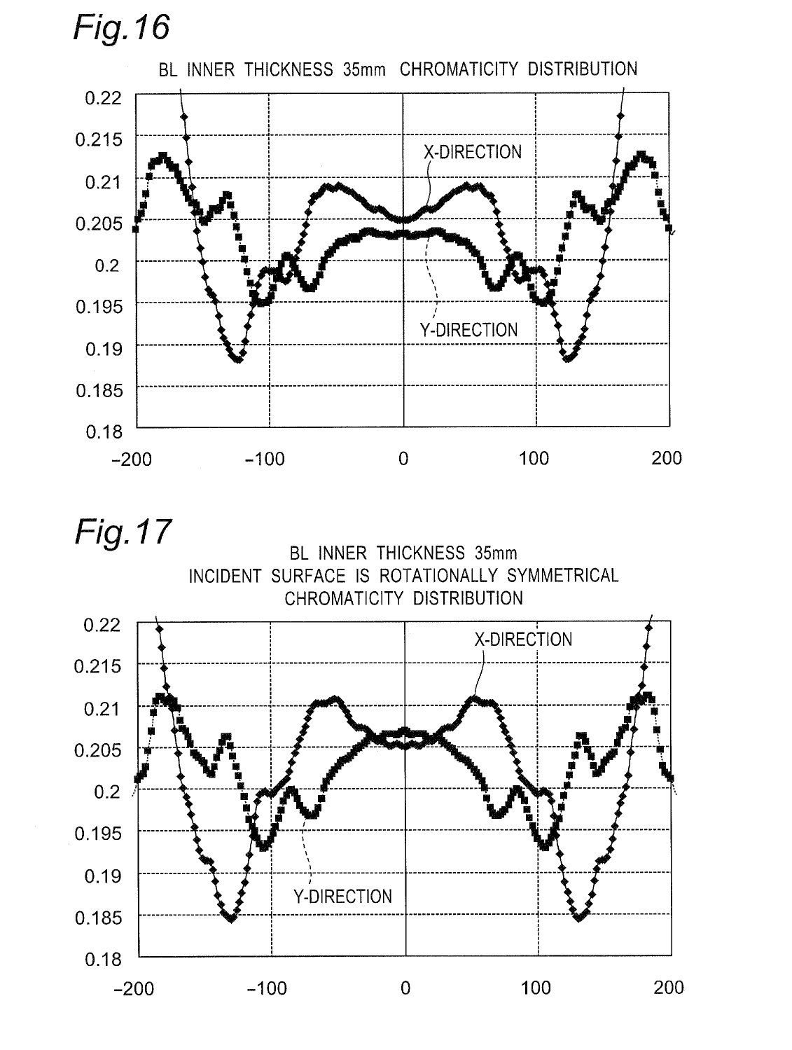

FIG. 16 illustrates a distribution of a Y value of the chromaticity on the irradiated surface 4a of the diffuser plate 4 when the irradiated surface 4a is disposed at the position 35 mm away from the emission surface 21 of the light source 2 in the optical axis direction using the light emitting device 1 of Example 1. In FIG. 16, a vertical axis indicates the illuminance normalized by the maximum value, and a horizontal axis indicates the distance (mm) from the optical axis.

FIG. 17 illustrates a distribution of a Y value of the chromaticity on the irradiated surface 4a of the diffuser plate 4 in a case that an incident surface 31 of the lens 3 is constructed by a curved surface that is rotationally symmetrical with respect to the optical axis when the irradiated surface 4a is disposed at the position 35 mm away from the emission surface 21 of the light source 2 in the optical axis direction using a light emitting device having a configuration corresponding to that of Example 1.

As can be seen from FIGS. 16 and 17, the incident surface 31 of the lens 3 is formed into the anamorphic aspheric surface, which allows the color unevenness to be reduced on the irradiated surface 4a.

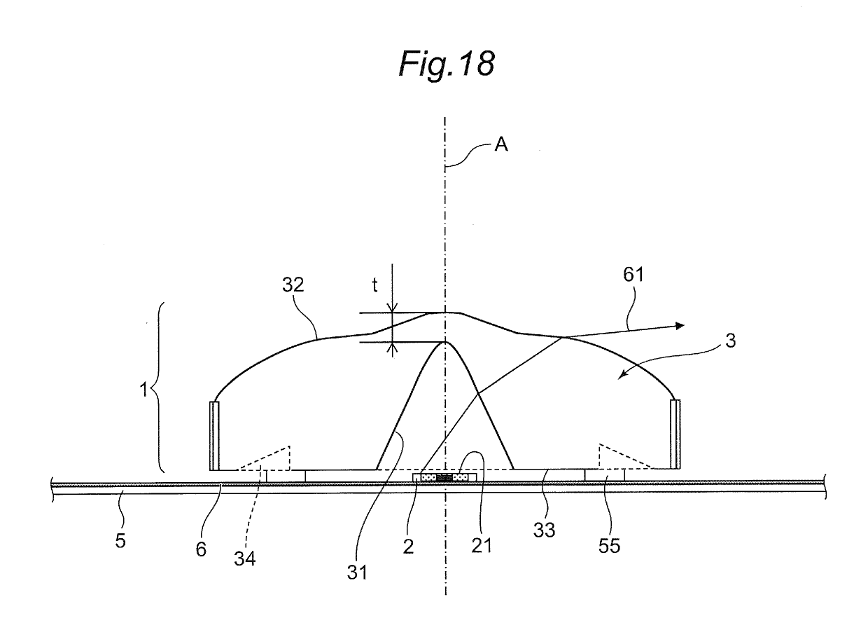

FIG. 18 illustrates a light path 61 of a light beam, which is emitted from a neighborhood of the end surface of the light source 2 with a large angle with respect to the optical axis A and reaches the incident surface 31. The light emitted from the light source 2 is transmitted through the lens 3 while refracted by the incident surface 31, and then reaches the output surface 32. The light reaching the output surface 32 is transmitted through the output surface 32 while refracted by the output surface 32, and then reaches the irradiated surface 4a of the diffuser plate 4. In FIG. 18, assuming that D is a maximum width of the emission surface 21 of the light source 2 and that t is a center thickness of the lens 3, the following expression (1) may be satisfied. The maximum width D of the emission surface 21 is equivalent to a diameter in the case that the emission surface 21 has the circular shape when viewed from above, and the maximum width D is equivalent to a diagonal distance in the case that the emission surface 21 has the rectangular shape when viewed from above.

0.3<D/t<3.0 (1)

A component of the Fresnel reflection that varies by a change in size of the light source 2 decreases when the above condition is satisfied. On the other hand, the size (for example, a length in the optical axis direction) of the lens 3 increases when D/t is less than a lower limit of the expression (1), and the Fresnel reflection component is easily generated when D/t is greater than an upper limit of the expression (1).

Assuming that D is the maximum width of the emission surface 21 of the light source 2 and that De is an effective diameter of the lens 3, the following expression (2) may be satisfied.

0.03<D/De<0.3 (2)

The Fresnel reflection component that varies by the change in size of the light source 2 decreases when the above condition is satisfied. On the other hand, the size (for example, the length in the direction perpendicular to the optical axis) of the lens 3 increases when D/De is less than the lower limit of the expression (2), and the Fresnel reflection component is easily generated when D/De is greater than an upper limit of the expression (2).

In a case of the use of a lens in which the output surface 32 is the concave surface, the light emitted from the light source 2 is transmitted through the lens while refracted by the incident surface 31, and then reaches the output surface 32. The light reaching the output surface 32 partially generates the Fresnel reflection on the output surface 32, is refracted by the bottom surface 33 of the lens 3, and travels toward the board 5. The light is diffusely reflected by the board 5, refracted by the bottom surface 33 again, transmitted through the output surface 32 while refracted by the output surface 32, and reaches the irradiated surface 4a of the diffuser plate 4. In such shape in which the Fresnel reflection is easily generated, since an influence of the Fresnel reflection component changes depending on the change in size of the light source 2, the illuminance distribution largely changes on the irradiated surface 4a, thereby restricting the size of the light source 2.

On the other hand, because the Fresnel reflection is hardly generated in the lens 3 of the embodiments, the influence of the Fresnel reflection can be reduced, and the restrictions to the size of the light source 2 and/or the shape can be reduced.

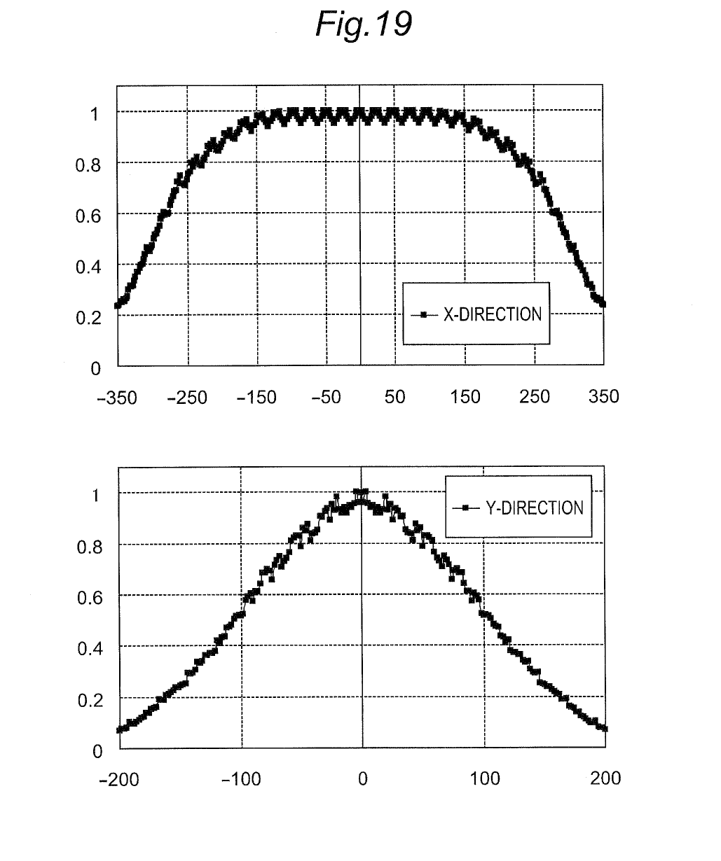

FIG. 19 illustrates an illuminance distribution on the irradiated surface 4a of the diffuser plate 4 when the 25 light emitting devices 1 of Example 1, in each of which the lens 3 in which the whole surface of the incident surface 31 is the anamorphic curved surface is used, are disposed in one line in the X-direction at a pitch of 24 mm while the two light emitting devices 1 are disposed in the Y-direction and when the irradiated surface 4a is disposed 35 mm away from the emission surface 21 of the light source 2 in the optical axis direction. In FIG. 19, a vertical axis indicates the illuminance normalized by the maximum value, and a horizontal axis indicates the distance (mm) from the optical axis.

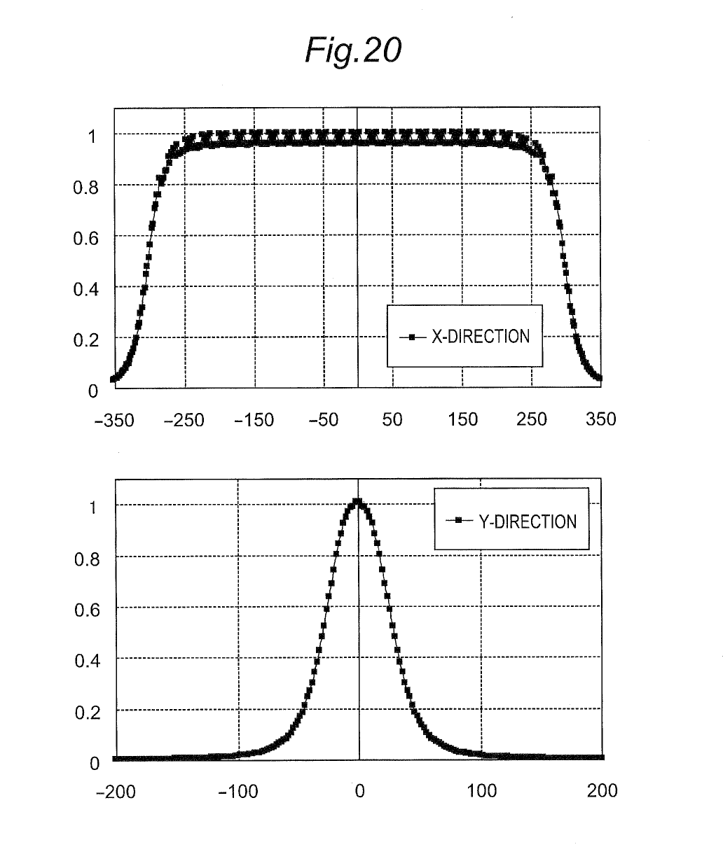

FIG. 20 illustrates an illuminance distribution on the irradiated surface 4a of the diffuser plate 4 when 25 LED light sources are disposed in one line in the X-direction at the pitch of 24 mm with no use of the lens 3 while two LED light sources are disposed in the Y-direction and when the irradiated surface 4a is disposed 35 mm away from the emission surface 21 of the light source 2 in the optical axis direction.

When the illuminance distribution in FIG. 19 is compared to that in FIG. 20, it is found that the illumination can evenly be performed on the irradiated surface 4a by the effect of the lens 3.

As above, the first to third embodiments are described as an example of the technology disclosed in the present patent application. However, the technology of the disclosure is not limited to the first to third embodiments. For example, the technology of the disclosure can also be applied to an embodiment in which a change, a replacement, an addition, an omission, and the like are properly performed.

It is to be noted that, by properly combining the arbitrary embodiments of the aforementioned various embodiments, the effects possessed by them can be produced.

Although the present disclosure has been fully described in connection with the embodiments thereof with reference to the accompanying drawings, it is to be noted that various changes and modifications are apparent to those skilled in the art. Such changes and/or modifications are to be understood as included within the scope of the present disclosure as defined by the appended claims unless they depart therefrom.

The components described in the accompanying drawings and the detailed description include not only components necessary for solving the problem but also components unnecessary for solving the problem for the purpose of the illustration of the technology. Therefore, it is to be noted that the fact that the component(s) unnecessary for solving the problem is described in the accompanying drawing(s) and the detailed description should not be immediately recognized that the component(s) unnecessary for solving the problem is the necessary component(s).

As described above, the present disclosure is useful to provide the surface light source having the small color unevenness and the sufficient brightness.

What is claimed is:

1. A surface light source comprising:
a light emitting device including a light source and a lens, the lens being configured to cover the light source and expand light from the light source; and
a diffuser plate configured to be disposed opposite to the light emitting device and be extended orthogonal to an optical axis of the light source,
the surface light source radiating light from a surface of the diffuser plate,
a plurality of the light emitting devices being disposed in line along one side of the diffuser plate while being opposite to a central portion of the diffuser plate,
the light source including a light emitting element and a fluorescent layer covering the light emitting element, a surface of the fluorescent layer being an emission surface, and
the lens configured to have different refractive powers in a first direction orthogonal to the optical axis and in a second direction orthogonal to the optical axis and the first direction.

2. The surface light source according to claim 1, wherein
the lens includes an incident surface through which the light from the light source is entered and an output surface from which the light entered into the lens is output, and
the incident surface includes an anamorphic and aspherical curved surface.

3. The surface light source according to claim 2, wherein
the output surface is a convex surface including the anamorphic and aspherical curved surface, and
the incident surface is a concave surface which is rotationally symmetrical with respect to the optical axis.

4. The surface light source according to claim 1, wherein the fluorescent layer is formed into a dome shape in the light source.

5. The surface light source according to claim 1, wherein the lens has a conditional expression of 0.03 <D/De<0.3, where D is a maximum width of an emission surface of the light source and De is an effective diameter of the lens.

6. The surface light source according to claim 1, wherein the lens has a conditional expression of 0.3<D/t<3.0, where D is a maximum width of an emission surface of the light source and t is a center thickness of the lens.

7. The surface light source according to claim 1, wherein the lens is disposed to substantially align a direction in which the lens has the weak refractive power with a direction in which the light emitting devices are arrayed.

8. The surface light source according to claim 1, wherein, in a state that the first direction differs from the second direction in a difference between an emission area of the light emitting element and an emission area from the fluorescent layer, the light emitting device is disposed to align a direction in which the lens has the weak refractive power with a direction in which the difference is larger.

9. The surface light source according to claim 1, further comprising:
a board configured to mount each of the light sources of a plurality of the light emitting devices and be disposed opposite to the diffuser plate; and
a reflecting member configured to cover the board while exposing the light source and be disposed between the board and the diffuser plate.

10. A liquid crystal display device comprising:
a liquid crystal display panel; and
a surface light source configured to be disposed at a back surface side of the liquid crystal display panel and have a size equivalent to the liquid crystal display panel,
the surface light source including: a light emitting device having a light source and a lens, the lens being disposed to cover the light source and expanding light from the light source; a diffuser plate configured to be disposed opposite to the light emitting device while being adjacent to the liquid crystal display panel and be extended orthogonal to an optical axis of the light source; a reflecting member configured to reflect the light output from the light emitting device toward the diffuser plate side; and a chassis configured to be closed by the diffuser plate while accommodating the light emitting device and the reflecting member,
a plurality of the light emitting devices being disposed in line along one side of the diffuser plate while being opposite to a central portion of the diffuser plate,
the light source including a light emitting element and a fluorescent layer covering the light emitting element, a surface of the fluorescent layer being an emission surface, and
the lens configured to have different refractive powers in a first direction orthogonal to the optical axis and in a second direction orthogonal to the optical axis and the first direction in the leans.
